(19) United States
(12) Patent Application Publication
(10) Pub. No.: US 2024/0269765 A1
(43) Pub. Date: Aug. 15, 2024

(54) HIGH-TEMPERATURE JOINING FURNACE

(71) Applicant: PVA Industrial Vacuum Systems GmbH, Wettenberg (DE)

(72) Inventors: Udo BROICH, Dillenburg (DE); Jörg WINHAUER, Dautphetal (DE); Jürgen NAUMANN, Linden (DE); Stefan EICH, Asslar-Berghausen (DE); Jan PFEIFFER, Staufenberg (DE); Patrick MÜLLER, Wetzlar (DE)

(21) Appl. No.: 18/567,821

(22) PCT Filed: Jun. 3, 2022
(86) PCT No.: PCT/DE2022/100420

§ 371 Date: Dec. 7, 2023

(30) Foreign Application Priority Data
Jun. 11, 2021 (DE) 10 2021 115 227.5

(51) Int. Cl. B23K 20/02; B23K 20/26; F27D 19/00

(52) U.S. Cl. CPC B23K 20/023; B23K 20/26; F27D 19/00; F27D 2019/0003

(57) ABSTRACT

An automatic high-temperature joining furnace is configured for diffusion welding materials to be joined, such as metals and metal workpieces. It comprises a heating chamber with a heating device, a workpiece receptacle arranged in the heating chamber for receiving a workpiece to be worked in the joining furnace, a pressing device arranged and designed to exert a pressing force on the workpiece, a sensor device for generating at least one sensor signal, and a control device designed for controlling at least the pressing device in response to the at least one sensor signal.

### TECHNICAL FIELD

The present disclosure relates to an automatic high-temperature joining furnace and a method for diffusion bonding.

### BACKGROUND

It is generally known that metallic workpieces can be joined by means of diffusion bonding. For example, a metallic workpiece can be diffusion welded if it is joined by a press under pressure at a high temperature. The diffusion bonding process is a complex procedure that depends on various influences and, even under the same process conditions, does not necessarily lead to a comparable or at least satisfactory result.

During the joining process, for example, the deformation of the workpiece must be taken into account. For example, if the workpiece to be joined has cooling channels or other bores or openings in its interior, the pressing force exerted on the workpiece can deviate locally, resulting in a different overall deformation compared to a solid body with identical dimensions. The previous history of the materials to be joined also plays a role with regard to the joining result; the grain sizes in the metal composite and the manufacturing process of the respective metal layers, for example by rolling, can be particularly relevant here.

The inventors of the present disclosure have therefore recognized that simply following standard literature values for, for example, a possible surface pressure to be applied to the workpiece does not readily lead to repeatable success in the joining process.

Even if different materials for different workpieces are basically identical, i.e., produced using the same manufacturing process and pretreated to the same temperatures, so that similar grain sizes can be assumed in the material, variations between materials must also be taken into account. This also applies if workpieces have been cut from the same piece of raw material. This can be even more difficult with certain materials and/or material combinations.

Even if a joining process is therefore monitored by a specially trained person, the possible number of joining processes running in parallel is limited, as an employee can only monitor one oven at a time. A complete process sequence can take 24 hours or more. In addition to intensive training, a high level of experience and understanding of the underlying processes is required on the part of the user, without which no satisfactory results, i.e., robust joining results, can be achieved. This is another reason why diffusion bonding of metals has so far been relatively uncommon in industry.

### BRIEF SUMMARY OF THE PRESENT DISCLOSURE

In the light of the before-mentioned, the present disclosure provides an automating process sequences, further improving joining results and providing consistent results.

The present disclosure pays attention to ensuring that consistently high-quality end results may be achieved during the joining process, even with different starting materials, for example, with regard to their microstructural characteristics, as is the case in a typical application.

In a diffusion bonding process, a workpiece or a batch is deformed in a controlled manner. Any existing pores in the joining material, recesses inside the workpiece, the number and size of the joining surfaces and also the previous history of the joining material are variables that can influence the process sequence. When force is applied to the workpiece or batch by a press, the material contact on the joining surfaces is improved, for example by reducing the surface roughness. In this way, inherent interdiffusion can be produced or induced. Pressing is therefore used to increase the contact surface in the area of the joining surface(s). These processes differ from workpiece to workpiece, whereby the differences can be so significant that a first component can be joined with sufficient strength, but a next component, which is to be joined with identical parameters, only achieves insufficient strength or quality. On the other hand, the shape of one component may be retained, while the next, otherwise identical component with identical parameters may, for example, suffer deformation in the area of a cooling channel due to the pressing process.

An automatic high-temperature joining furnace is provided, which is prepared, for example, for the diffusion bonding of joining materials. Joining materials can be metals. Metals can be any metal-containing materials or substances. For example, this includes metals such as iron, copper, aluminum, titanium, but also alloys such as high-grade steel or stainless steel, tool steels, superalloys, bronze, tin or others. Joining materials can also be non-metals or composite materials.

The automatic high-temperature joining furnace can also be set up for force-assisted soldering or sintering of components. For example, the automatic high-temperature joining furnace is set up for force-assisted material refinement with or without filler material.

The automatic high-temperature joining furnace comprises a heating chamber with a heating device. The heating device is designed to heat the interior of the furnace and the workpiece to the processing temperature.

A workpiece holder is arranged in the heating chamber to hold a workpiece to be processed in the joining furnace. The workpiece holder is arranged on the underside of the heating chamber. For example, the workpiece holder may comprise a plate, but the workpiece holder may also comprise holders into which the workpieces to be joined are to be inserted. The workpiece holder can be part of a counter-pressing element or be arranged on it.

The joining furnace also comprises a pressing device, which is arranged and designed to exert a pressing force on the workpiece. For example, the pressing device is arranged so that an upper part, such as a pressing punch, presses against the workpiece from above, whereby the workpiece is pressed against the workpiece holder or against the counter-pressing element. In other words, the workpiece is clamped between the upper part or pressing punch and the counter-pressing element or workpiece holder. The upper part can, for example, comprise a pressing plate, by means of which the pressing force can be evenly distributed over a surface so that the workpiece is pressed evenly. Depending on the intended use, the pressing plate can have a flat surface so that the workpiece can be evenly subjected to pressing force via the surface of the pressing plate. The press plate can also have recesses, protrusions or steps in order to shape the press plate to a desired surface of the workpiece or workpieces. The press plate could therefore be described in general terms as a “press element”. In the following, the term “press plate” is used, as this term appears to be more understandable for the skilled person in the light of the present description.

The press plate can be movable, for example the press plate is displaced by one or more pressing punches, whereby the pressing punch(s) is/are set in motion by one or more press cylinders. When a pressing force is applied, the workpiece is successively deformed or joined.

The pressing device can also be arranged in such a way that it presses onto the workpiece from below, for example by providing a movable workpiece holder and moving the workpiece upwards on the workpiece holder, for example. In a further embodiment of the disclosure, a first and second pressing plate can be provided for the application of force on both sides, for example an upper and a lower pressing plate or a left and a right pressing plate. The indicated directions “up” and “down” are only preferably aligned in the direction of the acting force of gravity; a “left” or “right” arrangement is also conceivable and should not lead out of the protected area; the “up” or “down” arrangement has desirable results.

To press the workpiece, one or at least one part functioning as a pressing punch is used, which can be subjected to a force from the outside, and a counter-pressing element, which counteracts the pressing force. The workpiece is clamped between the pressing punch and the counter-pressing element, where it is joined or deformed.

A sensor device in the joining furnace provides at least one sensor signal. For example, the sensor device can detect the position or extended length of the pressing punch, or the position of the press plate. A control device is also provided, which is designed to control at least the pressing device in response to the at least one sensor signal.

The sensor device of the joining furnace can detect a process parameter. A process parameter can be the thickness of the workpiece, the position of a pressure ram or pressing ram of the pressing device. A process parameter can also be the applied pressing force, a hydraulic pressure or a distance traveled by the pressing device. A sensor signal can then be generated from the value basis recorded by the sensor device, i.e., one of the aforementioned process parameters. Several sensor devices can be provided in order to record different process parameters simultaneously. A further sensor device can detect one or more process parameters at the same time as the first sensor device and thus generate at least one or more further sensor signals. The one or more sensor signals can be processed to control the joining process or the joining furnace, so that different process parameters can be taken into account in the control.

The pressing device can comprise a hydraulic device, whereby the pressing force is built up by building up hydraulic pressure. The pressing device can also include an electric spindle which, for example, generates a feed by rotation and applies the pressing force to the workpiece.

The joining furnace can include an input device for entering process parameter settings. The input device can be a user-operated terminal, for example. Process parameter specifications that can be stored before the start of the joining process are, for example, the desired process temperature, the process time, the material or materials of the workpiece, parameters or other data on the underlying material and the number and/or amounts of the joining surface or joining surfaces of the workpiece. In other words, some of the process parameters can be stored by an operator and some can be generated or calculated by the joining furnace without further operator intervention. If necessary, the joining furnace can determine all process parameters itself without any operator input. In an embodiment, the operator only enters component information, i.e., various details about the component(s) used. Component information can be the net joint area to be welded, the material of the component(s), the thickness and/or the permissible total plastic deformation. Preferably, no welding process-dependent specifications need to be entered by the operator so that, in other words, the welding process-dependent process parameters are determined independently by the joining furnace.

For example, the workpiece can consist of a number of layers of different materials, for example at least two different materials which are stacked on top of each other, whereby each surface to be joined between two different materials is described as a joining surface. In the case of a plate-like workpiece comprising 25 layers, for example, 24 joining surfaces are thus arranged in the workpiece. Information about cavities in the workpiece can also be taken into account in the process parameter specifications.

The joining furnace can also include an output device, which may display or select process parameters and/or a control program. For example, information on which process step the joining furnace is currently in can be displayed on the output device.

The pressing device can comprise a pressing plunger with which the pressing force is transferred and/or it can comprise a pressing plate with which the pressing force is applied to the workpiece.

The pressing device can comprise a pressing cylinder. The pressing punch can be connected to the press cylinder so that the press cylinder acts on the pressing punch with the pressing force and adjusts the pressing punch in the direction of the workpiece. The pressing device may comprise several pressing cylinders, for example 2, 3 or 4 pressing cylinders.

It is desirable to use several pressing punches which act together on the workpiece, for example via the pressing plate, which is subjected to pressing force by the two or more pressing punches as homogeneously or in a distribution over the surface as even as possible. The several pressing punches can be arranged next to each other so that an array of pressing punches acts on the pressing plate. The aim here is to distribute the pressing force as homogeneously as possible on the workpiece to be joined, as the pressing force required for joining can otherwise deform the press plate or the press element so that the workpiece to be joined is not uniformly subjected to pressing force.

The high-temperature joining furnace can comprise a housing. For example, the heating device, heating chamber, workpiece holder and/or pressing device can be accommodated in the housing. The pressing device can be arranged on the housing by means of a press mount and/or be supported on the housing. For example, the press mount is attached to the housing or rests against the housing so that the press cylinder connected to the press mount can be supported against the housing of the high-temperature joining furnace.

The housing can have a support or retaining structure such as a support frame or support cage to support the pressing device. The support or retaining structure can be a component separate from the housing or integral with the housing.

The support or holding structure and/or the press mount can be designed to be movable and/or deformable. For example, the pressing device can be supported against the press mount when a pressing force is applied to the workpiece, thereby displacing and/or deforming the press mount, for example by deforming the supporting or holding structure. Here, a storage force can be absorbed between the press mount and the pressing device, for example the press cylinder with pressing punch, similar to the pretension of a spring, so that the pressing effect on the workpiece can be increased evenly or more gently, for example when the pressing force is increased. The movable and/or deformable design of the press mount or the support or holding structure can be used to prepare the pressing device, in which the pressing device is prepared in an initial position in which a pre-pressing force is already applied to the workpiece. This pre-pressing force can be more finely dosed and therefore more precisely adjusted if the press mount is movable and/or deformable.

The joining furnace can be set up in such a way that a lateral displacement and/or deformation of the press mount takes place by means of the application of the compressive force by the pressing device on the workpiece. In other words, the application of the compressive force to the press mount, which acts as an abutment for the press, causes the lateral displacement and/or deformation of the press mount. By absorbing compressive force in or in the area of the press mount, a spring effect is generated between the press mount and the pressing device or between the press mount, press cylinder and pressing punch.

The pressing device can be set up in such a way that a pre-tensioning force can be built up between the pressing punch and the housing during a pressing process or when a pressing force is built up. The presence of a pre-tensioning force in the pressing device allows finer dosing and therefore more precise detection and/or tracking of the punch position during the pressing process. Furthermore, the build-up of the pre-tensioning force allows more precise setting or metering of pressure corrections or pressing force corrections.

For example, the press mount can be displaced or deformed by more than 1 mm when a compressive force is applied, for instance more than 3 mm, or more than 5 mm, or even more than 10 mm. This can form a type of “spring mechanism”, i.e., a preload force. The press mount can also be displaced or deformed by less than 3 mm, preferably less than 6 mm, more preferably less than 12 mm, when a compressive force is applied; minimum and maximum deflection values can be combined as an interval, for example more than 3 mm and less than 6 mm as “in the range between 3 and 6 mm”.

The sensor device can be set up to detect the position of the pressure stamp. The sensor device can also be designed to detect the pressing force that is applied to the workpiece.

The sensor device may be adapted to detect the position of the plunger with an accuracy of at least ±10 μm or less, i.e., 10 μm or better. If necessary, the sensor device can detect the position of the pressure stamp to an accuracy of ±1 μm or less, further preferably ±0.1 μm or less. On the other hand, the measurement resolution of the sensor device with respect to the position of the printing stamp may be ±1 μm or more, preferably ±0.1 μm or more, more preferably ±0.05 μm or more.

The control device can be set up to determine a pressing force required for the inserted workpiece for a joining process by recording and evaluating the sensor signal(s). Furthermore, the control device can automatically control the pressing device based on the determined required pressing force. In other words, the control device controls the pressing device taking into account the recorded or evaluated sensor signals.

If necessary, the control device can also regulate or control the heating device so that different temperatures can be maintained in the heating chamber at different times during the joining process.

The joining furnace can have a filling and removal opening. In one example, the filling and removal opening is connected to a safety circuit that detects the status of the opening.

The workpiece holder can serve as a counter-pressing element for the pressing device. The pressing device can therefore press the workpiece against the workpiece holder so that the workpiece is clamped between the pressing device and the workpiece holder.

The control device can provide at least one selectable control program. The selectable control program can preselect basic parameters, for example a typical pressing force that is frequently applicable for a certain material combination, or a minimum pressing tension with which the joining process can be started. The selectable control program can include a pre-treatment program and/or a press execution program.

The control device is preferably designed to adapt a selected control program in response to at least one sensor signal, for example during the execution of the control program. The control program can be adapted in such a way that process parameters, such as, for instance, the pressing force, temperature and/or path of the pressing device, are changed or influenced during the joining process.

In other words, the control device can be designed to detect and process at least one sensor signal during the execution of the control program—i.e., during a welding process—and to use it to change the control parameters for the welding process.

The at least one control program can be stored in a program memory of the high-temperature joining furnace. The control device can comprise or be formed by a programmable logic controller.

The present disclosure further describes a method for diffusion bonding in an automatic high-temperature joining furnace, for example in such an automatic high-temperature joining furnace as described above. The method for diffusion bonding comprises the steps of filling the joining furnace with a workpiece; heating the workpiece to a joining temperature; pressing the workpiece with a pressing device for carrying out the diffusion bonding process; during pressing, detecting or determining the pressing force required for the joining process, for example with an automatic control device; and controlling the pressing device in response to the detected or determined pressing force required for the joining process. For example, the required pressing force can be determined via the pressing path by means of distance measurement.

The method can also be further developed by the step of repeatedly detecting or determining the pressing force required for the joining process, for example at fixed time intervals, and adaptively controlling the pressing device in response to the repeatedly detected or determined pressing forces.

The method can also be further developed with the step of continuously monitoring the joining process by means of at least one sensor device, and continuously adapting the joining process when a deviation of a monitored value from a target value is detected.

The method can also be further developed with the step of entering process parameter specifications, for example by a user, before pressing the workpiece.

In addition, the step of taking into account the process parameter specifications when providing setpoints for the automated process control can also represent a further development of the method.

In the following, the present disclosure is explained in more detail with reference to embodiments and with reference to the figures, whereby identical and similar elements are sometimes provided with the same reference signs and the features of the various embodiments can be combined with one another.

### BRIEF DESCRIPTION OF THE DRAWINGS

FIG. 1 is a first embodiment of a high-temperature joining furnace in side sectional view with inserted workpiece,

FIG. 2 is a further embodiment of a high-temperature joining furnace in side sectional view, with the pressing device exerting a pressing force on the workpiece,

FIG. 3 is a further embodiment of a high-temperature joining furnace in side sectional view with different pressing device,

FIG. 4 is a perspective view of a high-temperature joining furnace,

FIG. 5 provides another perspective view of a high-temperature joining furnace,

FIG. 6 is a perspective view of a high-temperature joining furnace with peripheral attachments,

FIG. 7 is a top view of a high-temperature joining furnace,

FIG. 8 is a perspective view of a high-temperature joining furnace,

FIG. 9 is a flow chart for a joining process.

### DETAILED DESCRIPTION

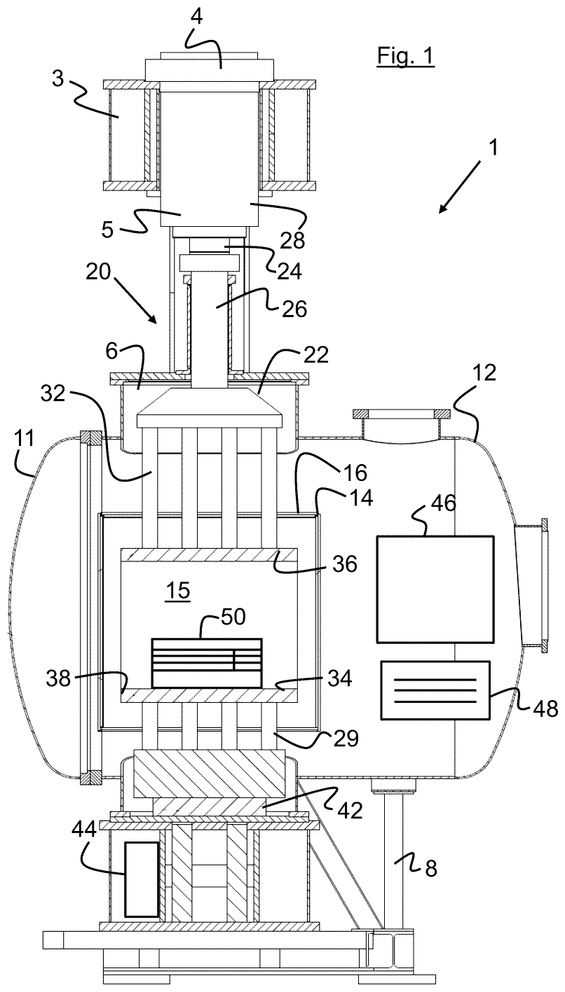

FIG. 1 shows a first embodiment of a high-temperature joining furnace 1 with a heating chamber 15 arranged inside the housing 12, in which a workpiece 50 is arranged for a subsequent pressing process. The joining furnace 1 has a filling or removal opening 11 through which the workpiece 50—or several workpieces 50 or a batch—can be inserted into or removed from the heating chamber 15. The workpiece 50 lies on the workpiece holder 34, which is arranged on the underside of the heating chamber 15. The workpiece holder can be the counter-pressing element 38 or can be arranged on the counter-pressing element 38. In the example shown in FIG. 1, the workpiece 50 rests directly on the counter-pressing element 38.

In this embodiment, the pressing device 20 is arranged on the upper side of the housing 12 of the joining furnace 1 in order to be able to develop a pressing force from above onto the workpiece 50 and against the workpiece holder 34 or the counter-pressing element 38. A plurality of pressing punches 32—four pressing punches 32 in the example shown in FIG. 1—are connected to a press cylinder 24. The pressing cylinder 24 is, for example, a hydraulic cylinder, whereby the pressing punches 32 are set by the pressing cylinder 24 via the transmission piece 26 in the direction of the workpiece 50. A pressure distribution element 22 is arranged in the receiving area 6 of the housing 12 in order to distribute the pressing force of the pressing device 20 to the plurality of pressing punches 32.

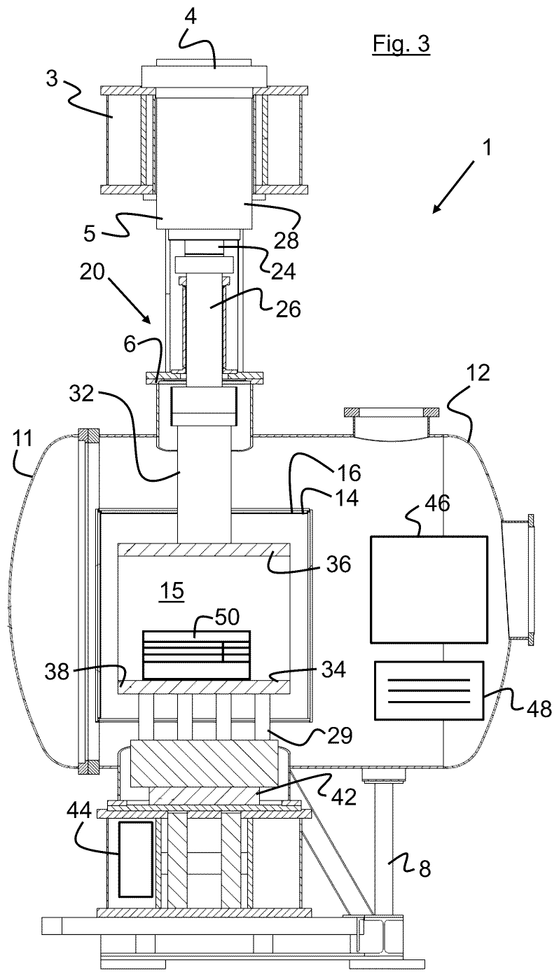

Instead of the plurality of pressing punches 32, a single pressing punch 32 can also be used if necessary (see FIG. 3). The plurality of pressing punches 32, e.g., 4, 8 or 12 pressing punches 32, can on the one hand distribute the pressing force evenly (more evenly) over the pressing element 36. For example, an improved thermal sealing of the heating chamber 15 can also be achieved with the aid of the plurality of pressing punches 32, since each pressing punch 32 requires only a comparatively small opening in the insulation 16 of the heating chamber 15, so that the energy losses from the heating chamber 15 can be lower. In addition, by using a plurality of pressing punches 32, the thermal energy losses can also be better equalized via the outer surface of the heating chamber 15 and an overall improved homogenization of the temperature distribution in the heating chamber 15 can be achieved. This also applies analogously to the counter-pressing plungers 29 on the underside of the heating chamber 15, whereby the considerations of the more homogeneous pressure distribution over the counter-pressing element 38 as well as the lower and/or more uniform heat losses are taken into account.

A press force generator 28, in this example a hydraulic unit 28, applies pressurized hydraulic fluid to the press cylinder 24 so that it is released or disengaged by the press force generator 28 and applied to the workpiece 50. For example, motor units 3 can generate the hydraulic pressure in the press force generator 28.

A first sensor device 4 is arranged on the upper side, which is used to measure the path of the press cylinder 24. Accordingly, the first sensor 4 detects the distance of the press cylinder 24 or the distance of the pressing punch 32 or the extension (stroke) of the press cylinder 24 and provides a first sensor signal 170 from this. A further sensor 5 can be arranged in the pressing force generator 28 and/or in the pressing cylinder 24, for example for measuring the hydraulic pressure, in order to derive information about the applied pressing force and provide it as sensor signal 170.

The workpiece holder 34 is arranged within the heating device 14 in order to accommodate the workpiece 50 in the heating chamber 15. Also in order to impair the insulation 16 accommodating the heating chamber 15 as little as possible, the workpiece holder 34 is provided with a plurality of counter-pressing punches 29 which dissipate the force distribution from the counter-pressing element 38 as evenly as possible, so that the counter-pressing element 38 is subjected to as little deformation as possible. Since the counter-pressing punches 29 pass through the insulation 16 and the insulation 16 should be impaired as little as possible, a comparatively small penetration area can be caused overall or the counter-pressing punches 29 can be better thermally sealed.

A second sensor device 42 is also arranged on the underside, which can, for example, detect the pressing force applied to the workpiece 50. For example, the second sensor device 42 is a pressure sensor. A plurality of two or more pressure sensors can also be used as the second sensor device 42, for example one each in the area of a counter-pressing punch 29, so that the pressure distribution acting on the counter-pressing element 38 can be detected and output as a sensor signal. In this way, it is possible to detect whether the pressure distribution on the workpiece or the charge 50 occurs in the desired manner, for example homogeneously over the workpiece or the charge 50.

In an alternative embodiment, a pressing force can be exerted on the workpiece or the charge 50 from both sides. For example, the embodiment of FIG. 1 can be modified so that instead of the (passive) subassembly, which for example comprises counter-pressing punch 29 and counter-pressing element 38, a further pressing device 20′ is arranged on the underside of the high-temperature joining furnace.

In this example, an automatic process control 44 is arranged in the area of the substructure 8 of the joining furnace 1. The input device 48 and the output device 46, for example keyboard 48 and screen 46, enable input and output to the control device 44 and thus manual influence on the process sequence or input of process parameters.

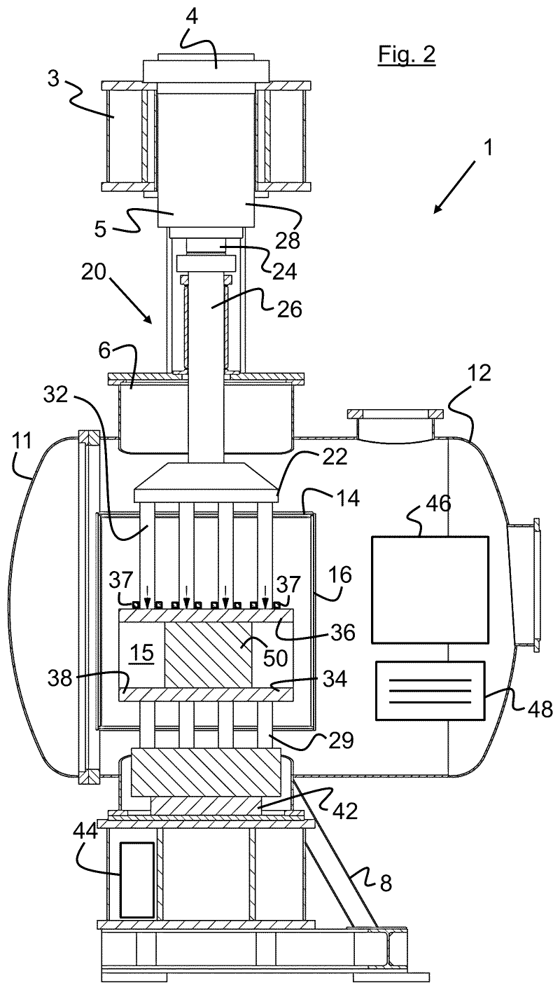

With reference to FIG. 2, the pressing device 20 is shown in an operating position, whereby the pressing plate 36 is fully positioned against the workpiece 50 and a pressing force is applied to the workpiece 50. The press cylinder 24 or the transfer piece 26 is shown in the disengaged position. In this embodiment, the pressing punches 32 are each equipped with two pressure distribution pieces 37, which are arranged at an angle between the press plate 36 and the respective pressing punch 32 and help to transfer the pressing force even more homogeneously to the press plate 36.

The pressing force applied to the workpiece 50 by the pressing device 20 can be detected by the pressure sensor(s) 42, whereby this is transmitted to the control device 44 as sensor signal 170. Otherwise, the embodiment of FIG. 2 corresponds to that shown and described in FIG. 1.

FIG. 3 shows a further embodiment of the joining furnace 1 in which a pressing punch 32 transmits the force from the press force generator 28 to the press plate 36. This more compact design can be selected where appropriate if the pressing plate 36 is designed accordingly to distribute the pressing force over the surface in such a way that uniform deformation of the workpiece 50 can be achieved.

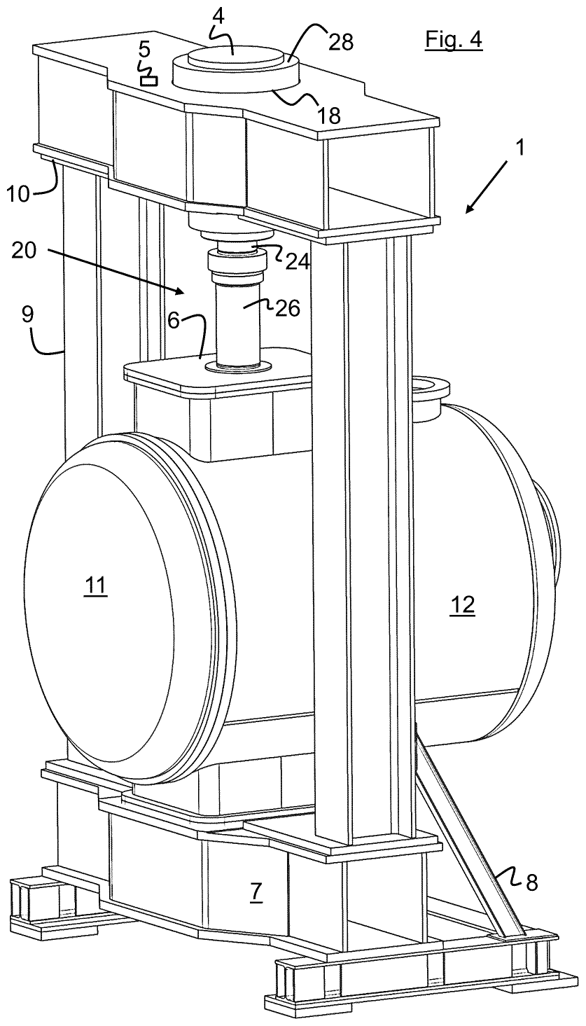

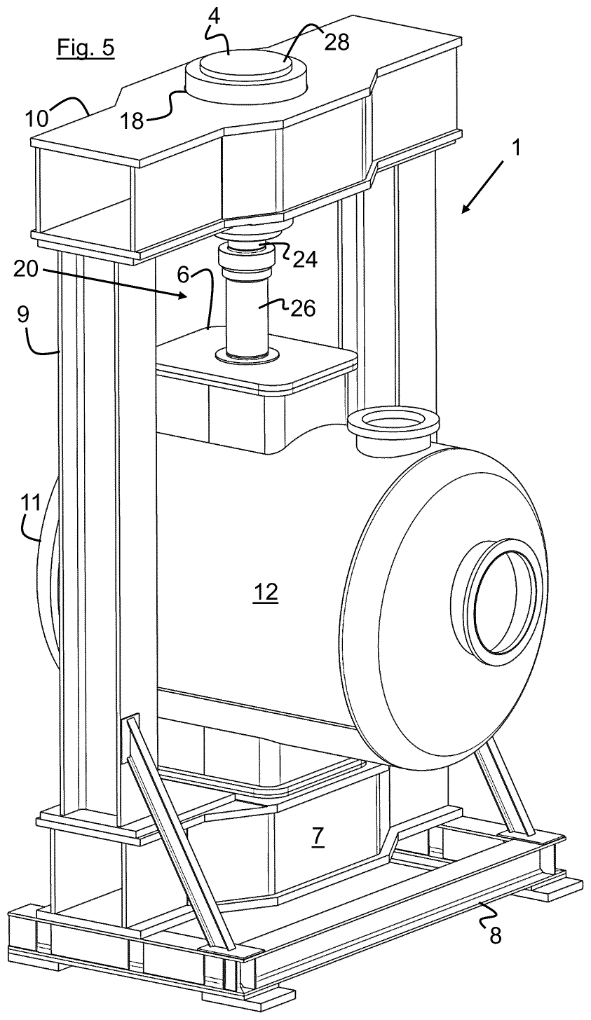

With reference to FIGS. 4 and 5, a further embodiment of a high-temperature joining furnace 1 is shown, wherein an outer frame 7, 9, 10 is included to support the pressing device 20. The pressing cylinder 24 is mounted by the supporting frame element 10, so that the pressing force can be transferred from the pressing device 20 to the workpiece 50 (see FIGS. 1 to 3) arranged inside the high-temperature joining furnace 1. When the pressing force is applied, the total force is absorbed by the outer frame 7, 9, 10, which can bend up in one direction away from the joining furnace 1 during operation. The bending up of the outer frame 7, 9, 10 provides a dynamic bearing for the pressing device 20, so that a press abutment 18 is formed by the outer frame 7, 9, 10.

In other words, the pressing device 20 is supported on the outer frame 7, 9, 10 at a “support point” in order to brace itself to apply the pressing force to the workpiece 50. The support point is referred to as press abutment 18, as the “support point” forms an abutment for absorbing the pressing force. In FIGS. 4 and 5, press abutment 18 is therefore only the place where the pressing device 20 is supported. The pressing device 20 can be bolted to the support or outer frame 7, 9, 10 or non-detachably connected to it.

In FIG. 4, a position sensor 5 is provided with which the positional displacement of the press abutment 18 can be detected. The positional displacement can also be used to draw conclusions about the pressing force applied by the pressing device 20 and the information can be provided as a sensor signal.

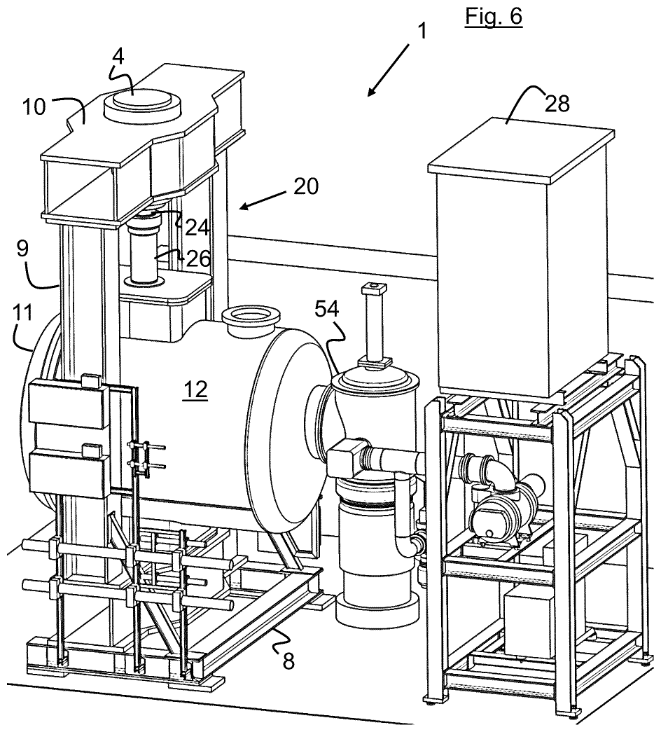

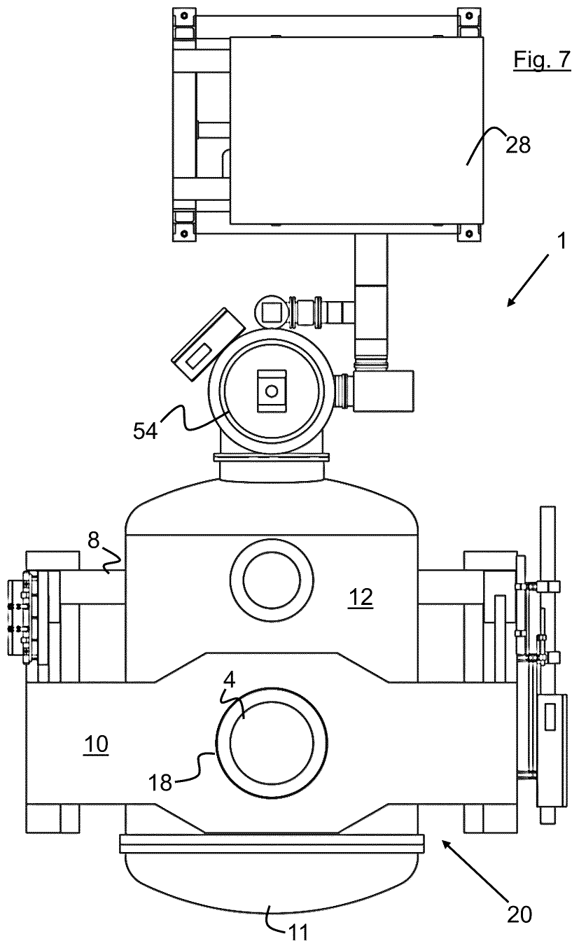

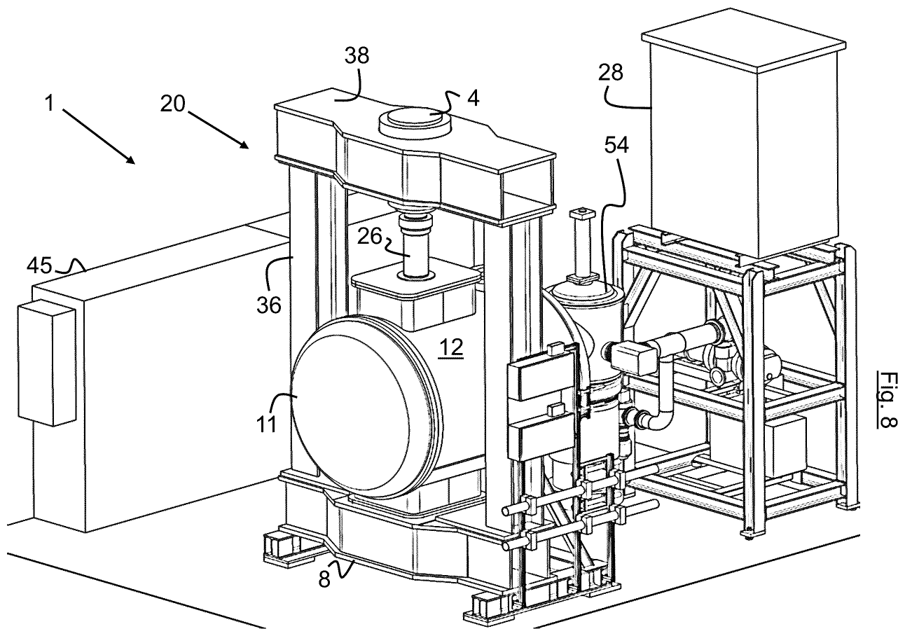

FIGS. 6 to 8 show a further embodiment of a high-temperature joining furnace 1, which is now shown completed with further attachments. A vacuum generator 54, for example a turbomolecular pump, provides a vacuum extraction system so that the joining process in the high-temperature joining furnace 1 can be carried out in conditions close to a vacuum, for example close to a high vacuum or an ultra-high vacuum. The pressing force generator 28 is located in a separate housing, so that a larger unit can be accommodated there if necessary. An input and/or output device 48, 46 is arranged in a user terminal 45, which comprises the PLC 44 and input/output 48, 46.

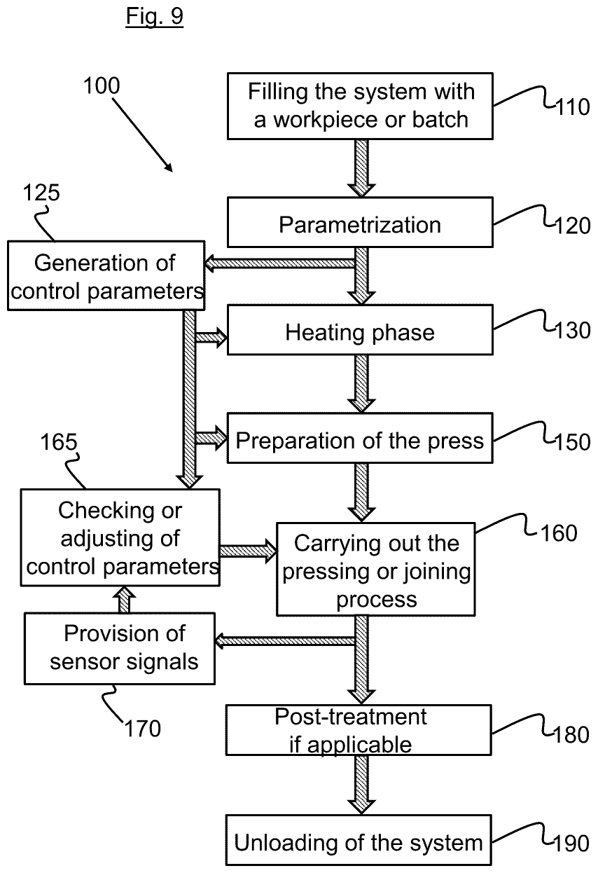

With reference to FIG. 9, a flow diagram of a joining process 100 is shown. In a first step 110, the system is filled with a workpiece or a batch of one or more workpieces. This is typically carried out by a user, but can also be automated.

In a step 120, the system is parameterized. Here, various specifications, such as, for instance, the materials and joining surfaces of the workpiece or the batch 50, can be stored in the control device 44 using an input device 48. For example, the intended compression of the workpiece 50 or the batch can also be entered as a percentage or distance, e.g., in millimeters. Temperature specifications can also be stored, for example. The parameters entered for step 120 are transmitted to the control device 44. By means of the control device 44 a set of control parameters can be generated in step 125. After closing the filling opening 11, the joining furnace 1 is ready for operation. The heating phase 130 begins with temperature parameters provided by the control unit 44.

In step 150, the press is prepared. This can include applying a pre-pressure to the pressing device 20 so that the abutment 18 undergoes a displacement or deformation or pre-tensioning and thus an initial position of the pressing device 20 can be assumed.

The pressing process or the joining process is then carried out in step 160 and monitored and adjusted by the automatic process control 44. Sensors 4, 5, 42 supply sensor signals 170, which are processed by the process control 44. In step 165, the prepared control parameters are checked or adapted in response to the sensor signals 170 provided by the sensors 4, 42. If the control parameters are adapted, the joining process 160 is continued in a modified form using the adapted control parameters from step 165. This can be implemented as a control loop and can be carried out iteratively, for example, so that an improved parameter configuration can be set in the course of the joining process and an improved joining result can be achieved.

In other words, in an example with step 120, a welding time-dependent distance is specified as a parameter value. The welding time-dependent distance can be specified by the system control; that is, the system control can be set up to determine, record or calculate the distance dependent on the welding time. For example, the distance to be covered can be determined for the press cylinder 24 or the press ram 32. In step 150, an initial application of a pressing force takes place and applies it, and in step 160 the actual pressing process begins. During the execution of the pressing process 160, it is checked 165 whether the corresponding distance per time unit has been reached and, if necessary, the pressing force is changed.

### Expert System

The Operator is only required to provide component information on net joint area, material, thickness, permissible total deformation, but no process information needs to be specified by the user.

No process knowledge is required: Welding temperature, upsetting, setpoint force specifications, and the user does not have to arrive at process parameters by trial and error. The development time is reduced, process does not have to be “designed”, a process engineer is no longer necessary, process design can take days to 1-2 weeks, system fluctuation from one system to the next.

Process parameters are derived from the component information and generated in the control system.

System knows approximate force range, target value is the amount of deformation of the component.

Displacement sensor, punch moves (abutment of the punch?).

Displacement sensor is located outside the vacuum chamber and on the outside of the press cylinder in a cold environment.

System is preloaded (compressed, elasticity) e.g., cylinder makes 5 mm, component goes down 0.3 mm (reversible deformation).

Obtaining a plastic deformation of the component is targeted.

But the plastic deformation is not measured on the component itself, but rather by means of indirect measurement.
Tiny deformation (creep; deformation rate) must be detected in order to be able to adjust it
Expert specification generates purely reversible (elastic) starting force (response of the system)
Then wait 1 minute->pressing punch remains in position
Force increases e.g. 2200 tons->1.5 mm->punch stops?
Force increases e.g. 2400 tons->1.5 mm->punch stops?
   Force increases e.g. 2600 tons->1.5 mm->punch moves very slowly and continuously (creep rate)
   Welding time comes from expert system, is system default e.g. 30 minutes
   Now calculates e.g. 1 mm per 30 minutes
   Determines the creep rate of the pressing punch
   New step response after e.g. 1 minute, then determination of the creep rate (in micrometers)
   New step response, then creep rate may be too high, no increase in force (=feedback)
   What happens if the customer does not know the material or specifies the wrong material? System automatically recognizes the material through press response
   Different starting material->system is able to equalize

Here, for example, an increasing pressing pressure can already be stored in the set of control parameters generated with step 125, which is adaptively tracked in the course of the joining process 160. A maximum or desired deflection of the press cylinder 24 to a desired end value can also already be stored in the set of original control parameters. During the checking or adjustment of control parameters 165, it can also be determined whether the desired final value for the deflection of the press cylinder 24 and/or the deformation of the workpiece can be achieved without possibly exceeding a pressing pressure with which the workpiece or the batch 50 could possibly suffer damage or excessive deformation.

In a step 180, the workpiece or the batch 50 may be followed by post-treatment. This can be further tempering, further heating or cooling with a defined temperature constant. Following the post-treatment 180, the workpiece or the batch 50 is sufficiently cooled and can be removed from the system 1 in step 190.

It is apparent to the skilled person that the embodiments described above are to be understood as merely illustrative and that the present disclosure is not limited to these, but can be varied in many ways without leaving the scope of protection of the claims. Furthermore, it is apparent that the features, irrespective of whether they are disclosed in the description, the claims, the figures or otherwise, also individually define components of the present disclosure, even if they are described together with other features. In all figures, the same reference signs represent the same objects, so that descriptions of objects which may only be mentioned in one or at least not with respect to all figures can also be transferred to these figures, with respect to which the object is not explicitly described in the description.

1. A automatic high-temperature joining furnace, configured for diffusion bonding of joining materials, comprising:
a heating chamber with a heating device,
a workpiece holder arranged in the heating chamber for holding a workpiece to be processed in the joining furnace,
a pressing device arranged and adapted to exert a pressing force on the workpiece,
a sensor device for generating at least one sensor signal, and
a control device adapted to control at least the pressing device in response to the at least one sensor signal.

2. The joining furnace according to claim 1, wherein the sensor device is configured to detect at least one of the following process parameters; thickness of the workpiece, position of a pressing punch in the pressing device, position of the press abutment, pressing force, hydraulic pressure, or path of the pressing device or of the press cylinder or transmission piece; and/or to generate at least one sensor signal therefrom.

3. The joining furnace according to claim 1, further comprising at least one further sensor device for simultaneously detecting one or more process parameters and for generating at least one further sensor signal.

4. The joining furnace according to claim 1,
wherein the pressing device comprises a hydraulic device as a pressing force generator and builds up the pressing force by building up a hydraulic pressure and/or
wherein the pressing device comprises an electric spindle.

5. The joining furnace according to claim 1,
further comprising an input device, for inputting process parameter specifications, and/or
further comprising an output device, for displaying or selecting process parameters and/or a control program.

6. The joining furnace according to claim 1,
wherein the pressing device comprises a pressing plate, with which the pressing force is applied to the workpiece, and/or
wherein the pressing device comprises a pressing cylinder, and/or
wherein the pressing device comprises a plurality of pressing punches.

7. The joining furnace according to claim 1,
wherein the high-temperature joining furnace comprises an outer frame, and wherein the pressing device is arranged on the outer frame and/or is supported on the outer frame.

8. The joining furnace according to claim 7, wherein the outer frame is designed to be movable and/or deformable.

9. The joining furnace according to claim 7, further comprising a press abutment which is prepared in such a way that a lateral displacement and/or deformation of the press abutment takes place by means of the application of the compressive force by the pressing device to the workpiece.

10. The joining furnace according to claim 6, wherein the pressing device is set up in such a way that a pre-tensioning force can be built up to a supporting frame element during a pressing operation.

11. The joining furnace according to claim 1,
wherein the sensor device detects the position of the pressing punch and/or
wherein the sensor device detects the pressing force applied to the workpiece.

12. The joining furnace according to the claim 11, wherein the sensor means is adapted to detect the position of the pressing punch with an accuracy of at least ±10 μm or less, and/or with an accuracy of ±1 μm or more.

13. The joining furnace according to claim 1,
wherein the control device is designed to determine a pressing force required for the inserted workpiece for a joining operation by means of detection and evaluation of the sensor signal or signals and to automatically control the pressing device on the basis of the determined required pressing force.

14. The joining furnace according to claim 1, wherein the control device is adapted to additionally control the heating device.

15. The joining furnace according to claim 1,
wherein the workpiece holder serves as a counter-pressing element, and/or
wherein the pressing device presses the workpiece against the workpiece holder.

16. The joining furnace according to claim 1, wherein the control device provides at least one selectable control program, and/or a pressing program.

17. The joining furnace according to claim 16, wherein the control device is further prepared to adapt the selected control program in response to at least one sensor signal during the execution of the control program in such a way that process parameters are changed.

18. The joining furnace according to claim 17,
wherein the at least one control program is stored in a program memory of the high-temperature joining furnace, and/or
wherein the control device comprises a programmable logic controller (PLC).

19. A method for diffusion bonding in an automatic high-temperature joining furnace, according to claim 1, comprising the steps of:
filling the joining furnace with a workpiece,
heating the workpiece to a joining temperature,
pressing the workpiece with a pressing device for carrying out the diffusion bonding process,
detecting or determining the pressing force required for the joining process during the pressing, example by means of sensors and/or by means of an automatic control device, and
controlling the pressing device in response to the detected or determined pressing force required for the joining process.

20. The method according to claim 19, further comprising the step of repeatedly detecting or determining the pressing force required for the joining operation at fixed time intervals, and adaptively controlling the pressing device in response to the repeatedly detected or determined pressing forces.

21. The method according to claim 19, further comprising the step of continuously monitoring the joining process by means of at least one sensor device, and continuously adapting the joining process when a deviation of a monitored value from a setpoint value is detected.

22. The method according to claim 19, further comprising the step of entering process parameter specifications before pressing the workpiece, and taking the process parameter specifications into account when providing setpoint values for the automated process control.
